(19) United States
(12) Patent Application Publication
(10) Pub. No.: US 2019/0121329 A1
(43) Pub. Date: Apr. 25, 2019

(54) APPARATUS AND METHOD FOR INTEGRATING MULTIPLE PRODUCTS IN A SINGLE PROCESS

(71) Applicant: General Electric Company, Schenectady, NY (US)

(72) Inventors: Paul Weatherbee, Edmonton (CA); Emma Wu, Edmonton (CA)

(21) Appl. No.: 15/792,379

(22) Filed: Oct. 24, 2017

(51) Int. Cl. G05B 19/418; B33Y 50/02

(52) U.S. Cl. CPC G05B 19/41865; G05B 2219/39084; G05B 2219/31376; B33Y 50/02

(57) ABSTRACT

Individual parts or components are tracked as the individual parts or components move through or between a plurally of manufacturing processes or steps after the individual parts or components are separated from the single manufacturing platform (and from each other). The information in a work order associated with the parts is utilized to dynamically make real-time adjustments to any of the plurality of manufacturing processes or steps as the individual parts or components move through or between the plurally of manufacturing processes or steps.

### BACKGROUND OF THE INVENTION

### Field of the Invention

The subject matter disclosed herein generally relates to manufacturing processes, and, more specifically, to the serial movement of parts created by a batch process through one or more manufacturing processes.

### Brief Description of the Related Art

Different types of manufacturing processes are used to produce various types of goods and components. For example, metal printing processes are used to create various types of objects and components. Generally speaking, a quantity of metallic powder is spread over a platter or other flat surface. A laser is directed onto the metal to produce traces. Specifically, the impact of the laser melts the powder into a solid metal. More powder is then spread over the platter, and the process is repeated. In this way, an object (e.g., a nozzle) can be constructed as layers of metal are built-up over time.

It is desirable to understand the condition or potential defects of the objects that are created on a platter. To accomplish this goal, test areas (e.g., test strips) can be built-up and created on the same platter as the object. Then, a destructive test can be performed on the test areas or strips. For example, the test strips may have a strong force applied to them to see if the strips break or become damaged. In this way, potential weaknesses of the objects (e.g., the nozzles) are identified.

At some point, the objects produced on the platter are separated from the platter and each other so that they can undergo further manufacturing steps or processes. For example, if nozzles are the object being created, then the nozzles may need to be polished. In previous approaches, a separate work order is produced for each object (and separate work orders produced for the test strips). Unfortunately, when the separate works orders are used, all information concerning the testing is lost.

### Brief Description of the Invention

The present invention relates to tracking objects created in a batch process as these objects serially move through different manufacturing processes. In examples, a dynamic master electronic work order is created and this work order applies to and contains information concerning all parts created in a batch process (e.g., multiple objects formed on a platter). In aspects, information concerning destructive testing carries through and the work order follows a part through the entire manufacturing process. Advantageously, different part types can be created on a single platter, and the different types are tracked without having to create multiple individual work orders.

In many of these embodiments, approaches for fine-tuning manufacturing processes for components produced on a single manufacturing platform are provided. An electronic master work order is created. The work order includes information concerning each of a batch of parts or components that have been constructed together on a single manufacturing platform. Each of the parts or components is programmatically associated with the single electronic master work order.

The individual parts or components are tracked as the individual parts or components move through or between a plurally of manufacturing processes or steps after the individual parts or components are separated from the single manufacturing platform (and from each other). The information in the work order is utilized to dynamically make real-time adjustments to any of the plurality of manufacturing processes or steps as the individual parts or components move through or between the plurally of manufacturing processes or steps.

In aspects, the single manufacturing platform comprises a flat platter. In examples, the electronic master work order includes one or more of a part number of a part to be created, a part type, results of a destructive test, an identity of personnel that performed the test, and properties or attributes that were tested. Other examples are possible.

In others of these examples, each of the plurality of parts or components is automatically tracked. In still other examples, each of the individual parts or components is manually tracked, for example, by a technician.

In yet other aspects, the electronic master work order includes testing information. In some examples, the testing information comprises information associated with a destructive test. In some examples, the destructive test involves an application of excess temperature, pressure, force, or motion to a test strip on the manufacturing platform. Other examples of destructive tests are possible.

The adjustments can be made in different ways. For instance, the adjustments are made by a technician. In other examples, the adjustments are accomplished automatically, for example, by a control circuit.

In others of these embodiments, a system is configured to fine-tune manufacturing processes for components produced on a single manufacturing platform. The system includes a data storage device, a user interface, and a control circuit.

A control circuit is coupled to the data store device and the user interface. The control circuit is configured to create an electronic master work order, and the work order includes information concerning each of a batch of parts or components that have been constructed together on a single manufacturing platform. Each of the parts or components is programmatically associated with the single electronic master work order. The control circuit is configured to store the electronic master work order in the data storage device.

The individual parts or components are tracked as the individual parts or components move through or between a plurally of manufacturing processes or steps after the individual parts or components are separated from the single manufacturing platform.

The information in the work order is utilized to dynamically make real-time adjustments to any of the plurality of manufacturing processes or steps as the individual parts or components move through or between the plurally of manufacturing processes or steps.

In aspects, the single manufacturing platform comprises a flat platter. In other examples, the electronic master work order includes one or more of a part number of a part to be created, a part type, results of a destructive test, an identity of personnel that performed the test, and properties or attributes that were tested.

In some examples, each of the plurality of parts or components is automatically tracked by the control circuit according to sensed inputs (e.g., images sensed by cameras as the part serially passes through various manufacturing processes). In other examples, each of the individual parts or components is manually tracked by a human technician.

In other examples, the electronic master work order includes testing information. For instance, the testing information comprises information associated with a destructive test. In some examples, the destructive test involves an application of excess temperature, pressure, force, or motion. Other examples are possible.

In other aspects, the adjustments are made by a technician. In other examples, the adjustments are accomplished automatically by the control circuit.

### BRIEF DESCRIPTION OF THE DRAWINGS

For a more complete understanding of the disclosure, reference should be made to the following detailed description and accompanying drawings wherein:

FIG. 1 comprises a block diagram of an approach for fine-tuning manufacturing processes according to various embodiments of the present invention;

FIG. 2 comprises a block diagram and flowchart of an approach for fine-tuning manufacturing processes according to various embodiments of the present invention;

FIG. 3 comprises a block diagram of an approach for fine-tuning manufacturing processes according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

This present invention relates to processes (e.g., metal printing processes) that are used to create various types of objects. More specifically, the present invention is directed to creating and maintaining a dynamic master electronic work order that applies to and contains information concerning all parts created on a platter even when the objects are of different types. Information concerning destructive testing carries through and the work order follows a part through the entire manufacturing process. Advantageously, different part types can be created on a single platter, and the different types tracked without having to create, maintain, and/o process multiple individual work orders.

The present invention allows information obtained during execution of a batch process (e.g., creating various objects on a single platter) to be used in a serial process (e.g., a serial manufacturing process). The approaches described herein provide better parts, better visibility (e.g., technicians can see what happened in past), and a reduced number of work orders (less system overhead).

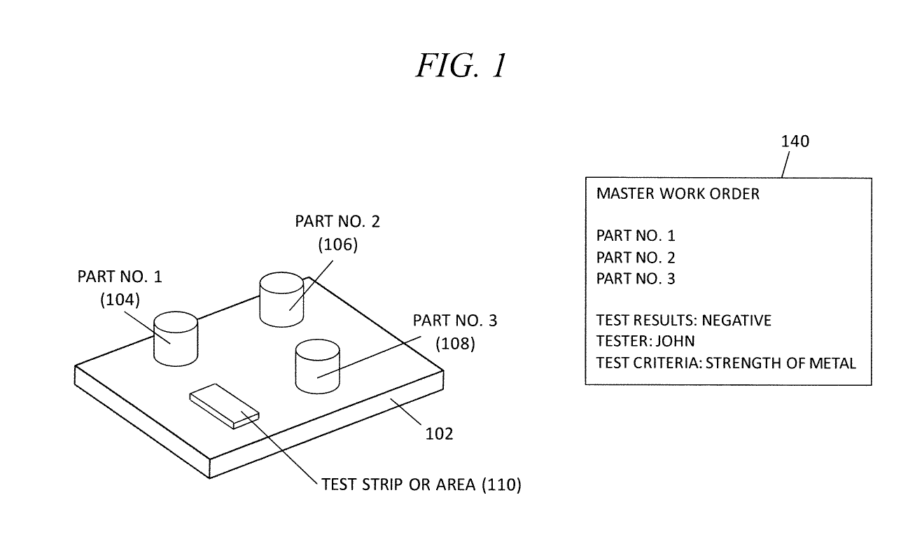

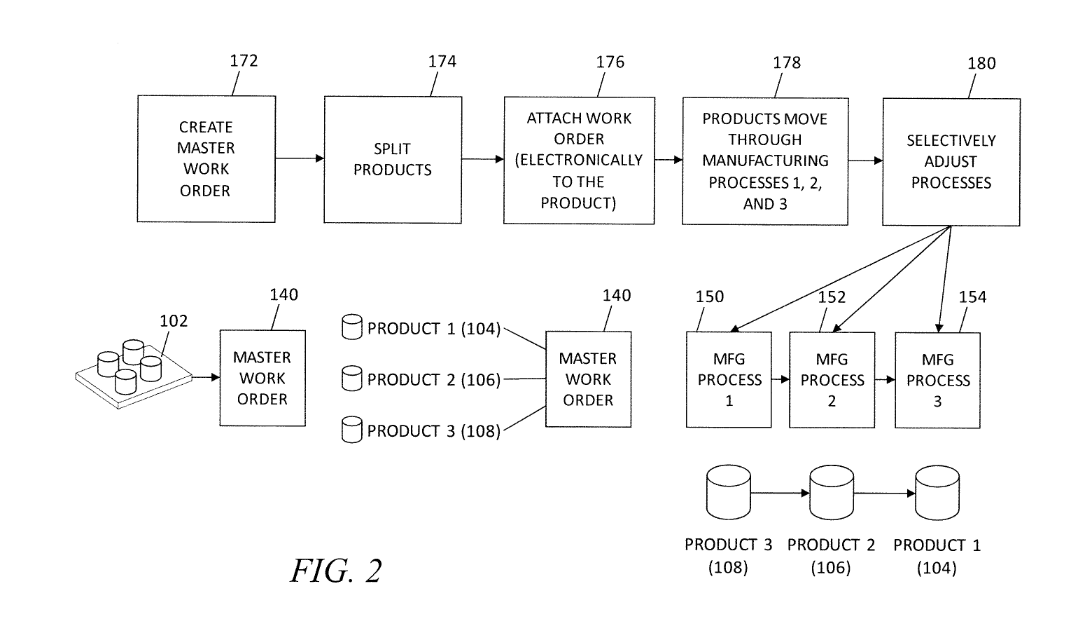

Referring now to FIG. 1 and FIG. 2, one example of an approach for fine tuning the operation of manufacturing processes using a single work order created in a batch process is described. Information obtained during execution of a batch process (e.g., creating various objects on a single platter) to be used in a serial process (e.g., a serial manufacturing process). A platter or base 102 includes a first part (with Part No. 1) 104, a second part 106 (with Part No. 2), a third part 108 (with Part No. 3), and a test strip 110. The platter 102 can be constructed of any suitable material (e.g., a metal in some cases).

The parts 104, 106, 108, and the test strip may be constructed according to various types of processes. For example, metal printing processes are used to create various types of objects and components. In aspects, a quantity of metallic powder is spread over the platter or base 102 (or some other flat surface). A laser is directed onto the metal to produce traces. Specifically, the impact of the laser melts the powder into a solid metal. More powder is then spread over the platter, and the process is repeated. In this way, the parts 104, 106, 108, and the test strip can be created. The parts 104, 106, and 108 can be various types of objects (e.g., a nozzle) and are constructed as layers of metal are built-up over time. The base of each of each of the parts, in aspects, is the platter 102. Thus, when the parts 104, 106, 108, are broken, cut, or separated from the common platter or base 102, they still include portions of the common platter base 102 and, as such, include properties of the common platter or base 102.

The test strip 110 can be of any configuration and is configured to accept test stimuli. In one example, it may be electrical traces. In other examples, it may be a built-up metallic structure. In examples, forces, pressures, temperature variations (e.g., heat and cold) may be applied to the test strip 110. The test strip 110 may break, become deformed, or may not have any change after application of the stimuli. These results can be recorded in the work order 120. Because the test strip 110 is constructed with the platter 102, the results apply to all parts created on or at the platter 102, even if those parts have different shapes, dimensions, or purposes.

At step 172, a master electronic work order 140 is created. The platter 102 may be analyzed either automatically or manually and the master electronic work order 140 is stored in a memory storage device 142.

At step 174, the parts 104, 106, and 108 are split or separated from the platter 102. In one example, a saw or other cutting tool is used to separate the products 104, 106, and 108. The outcome of step 174 is that products 104, 106, and 108 are physically separate from the others.

At step 176, the master work order 140 is attached or otherwise electronically associated with the products. For example, the work order 140 can store identities of the different parts or products to which it has an association. The master work order 140 has testing results that can be viewed manually by a technician or automatically analyzed.

At step 178, the products 104, 106, and 108 serially move through manufacturing processes 150, 152, and 154. That is, first product 104 moves through the processes 150, 152, and 154, followed by the second product 106, then followed by the third product 108. The manufacturing processes 150, 152, 154 may be any type of manufacturing process such as drilling, cutting, grinding, cleaning, or polishing a product. Other examples of processes are possible.

At step 180, the manufacturing processes 150, 152, or 154 can be manually or automatically adjusted based upon information in the work order. For example, if a stress test on a testing area or strip indicates a force limit (where the part would break upon application of a predetermined amount of force), then the amount of stress applied by the manufacturing processes onto parts as the parts move through the process is lowered.

Adjustments can be made automatically. For example, a computer program may determine an adjustment is needed to one of the manufacturing processes 150, 152, or 154 when a part (e.g., product 104, 106, or 108) is to be processed and the master work order 140 (upon analysis by the computer program) shows an adjustment would render a better product.

Adjustments can also be made automatically. For example, a technician may determine an adjustment is needed to one of the manufacturing processes 150, 152, or 154 when a part (e.g., product 104, 106, or 108) is to be processed and the master work order 140 (upon analysis by the technician) shows an adjustment would render a better product. In this case, the technician would take steps (e.g., re-programming, adjusting controls, or adjusting parameters) of the process.

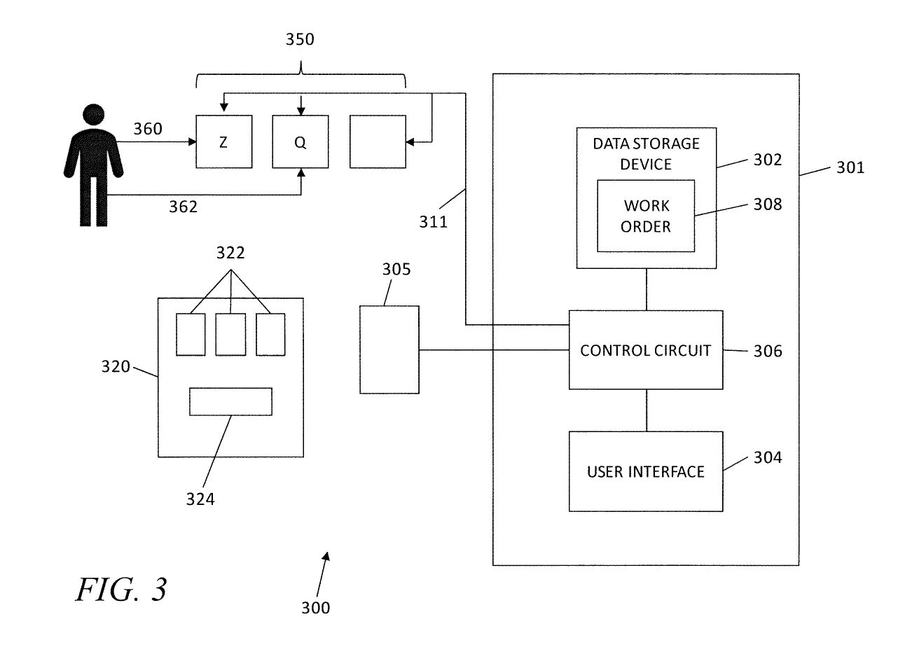

Referring now to FIG. 3, a system 300 is configured to fine-tune manufacturing processes for components produced on a single manufacturing platform in a batch process. The system 300 includes a data storage device 302, a user interface 304, and a control circuit 306.

A single manufacturing platform or platter 320 includes parts 322 and a test area or test strip 324 that have been built or constructed on the platform 320. In aspects, the single manufacturing platform 320 comprises a flat platter. The platform 320 may be constructed of any suitable material that can be used to construct parts or components.

After the parts 322 are constructed, they are physically separated from each other, and undergo further manufacturing processes or steps 350. For instance, the parts 322 may all be metal nozzles. Once each of the nozzles are separated from all the other nozzles, each of the nozzles may serially pass through three processes which first clean, second grind, and third polish the nozzle.

The data storage device 302 is any type of data storage device or electronic computer memory. The user interface 304 is any type of apparatus that is configured to render or present information to users. Additionally, the user interface 304 is configured to accept inputs from users. In examples, the user interface 304 may be a touch screen, or a computer screen and keypad, to mention a few examples. Other examples are possible.

The control circuit 306 is coupled to the data storage device 302 and the user interface 304. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 306 may be configured (for example, by using corresponding programming stored in a memory as will be well understood by those skilled in the art) to carry out one or more of the steps, actions, and/or functions described herein.

The control circuit 306 is configured to create an electronic master work order 308, and the work order 308 includes information concerning each of a batch of parts or components 322 that have been constructed together on the single manufacturing platform 320. Each of the parts or components 322 are programmatically associated with the single electronic master work order 308. For example, various structures such as linked lists or tables can be used to associate the master work order 308 to each of the various parts. The control circuit 306 is configured to store the electronic master work order 308 in the data storage device 302.

It will be appreciated that other work orders may also be created for batches of parts created or constructed on other platforms. These other work orders will be electronically attached to each part created on a particular platform.

The individual parts or components 322 are tracked as the individual parts or components 322 move through or between the manufacturing processes or steps 350 (i.e., after the individual parts or components 322 are separated from the single manufacturing platform 320).

The memory 302, user interface 304, and control circuit 306 may be disposed at one or multiple locations. In one example, the memory 302, user interface 304, and control circuit 306 are disposed at a central location 301. The central location 301 may be in the plant where the manufacturing processes are being performed. In another example, the central location 301 is at the cloud or other computer network (or combination of networks). In yet another example, the memory 302, user interface 304, and control circuit 306 are disposed at a mobile device such as a smart phone, a tablet, a laptop, or a personal computer. That is, element 301 is the mobile device. Other examples of locations (or combinations of these or other locations) are possible.

The information in the work order 308 is utilized to dynamically make real-time adjustments to any of the plurality of manufacturing processes or steps 350 as the individual parts or components 322 move through or between the plurally of manufacturing processes or steps 350. In one example, the electronic master work order 308 includes one or more of a part number of a part to be created, a part type, results of a test (or tests), an identity of personnel that performed the test, and properties or attributes that were tested. Other types of information may also be included in the work order 308.

When testing information is included, the testing information may comprise information associated with a destructive test or tests. In some examples, the destructive test involves an application of excess temperature, pressure, force, or motion. Other examples of destructive test information are possible.

In other aspects, the electronic master work order 308 is dynamically created when a batch of parts is constructed on the platform 320 (or some other base or platform). Information may be entered into the work order 308 manually, automatically, or in a combination of manual and automatic steps. For example, a technician may instigate the creation of the master work order 308 by making a request via the user interface 304. The request causes the control circuit 306 to create a data structure for the work order 308. The control circuit 306 then populates the work order with information supplied by the technician via the user interface 304. The electronic master work order 308 may be implemented as any data structure.

In still other examples, the electronic work order 308 is marked when the individual parts 322 are broken off from the platform 320. This master work order 308 then follows each of the parts 322 as the parts 322 move through the different manufacturing processes 350. In aspects, this approach allows a technician to view and the information in the work order 308 and make any adjustments on processes performed on the part to take into account the information. For example, if a destructive test on a nozzle indicated that the metal (or other material) used to construct the material was susceptible to breakage, then the technician could lower the amount of force being applied in a polishing process performed on the part.

In some examples, each of the plurality of parts or components 322 is automatically tracked by the control circuit 306 according to sensed inputs supplied by one or more sensors 305. The sensors 305 may be any type of sensors such as cameras. In other examples, each of the individual parts or components is manually tracked by a human technician.

As mentioned, automatic tracking of the part through the different manufacturing processes can be accomplished by the sensor 305 (e.g., a camera) following a particular product as it passes through the manufacturing processes 350. The sensed image can be analyzed by appropriate image analysis software at control circuit 306 as is known to those skilled in the art as the product passes through various manufacturing steps.

Manual tracking can be accomplished by a technician manually/visually following a part 322 as it moves through the various processes 350. A technician can retrieve the work order 308 and display it on at the interface 304 so as to be accessible to the technician (e.g., on a smart phone or other portable electronic device).

The adjustments to the manufacturing processes 350 can also be made in a number of different ways. In one example, the adjustments are made by a technician. In other examples, the adjustments are accomplished automatically by the control circuit 306.

When the adjustments are made manually, the work order 308 can be analyzed by a human technician who retrieves the work order for display at the user interface 304 (e.g., on display screen of an electronic device such as a smart phone). Testing results that might affect the settings of the manufacturing processes may be visually presented to the technician. In one particular example, if a test result indicates a force level of X results in part damage, then a setting Y on a manufacturing process Z can be adjusted to a first setting manually by the technician (shown in FIG. 3 as step 360). Another part with a different work order may then be processed. The second work order can be visually presented to the technician in the same way as the first work order. If a test result indicates a force level of A results in part damage, then a setting B on a manufacturing process Q can be manually adjusted to a second setting (shown in FIG. 3 as step 360).

For automatic adjustments, the work order 308 can be analyzed by computer software executed at the control circuit 306, for example, to determine testing results that might require or suggest adjustments to the settings of the manufacturing processes 350. For instance, if a test result indicates a force level of X results in part damage, then a setting Y on a manufacturing process Z can be adjusted to a first setting. Another part with a different work order may then be processed. If a test result indicates a force level of A results in part damage, then a setting B on a manufacturing process Q can be adjusted to a second setting. The control circuit 306 can receive sensed images, analyze the sensed images, receive work orders, and analyze the work orders. Once the analysis is complete, then an electronic control signal 311 can be transmitted from the control circuit 306 to the appropriate manufacturing process 350 (e.g., specifically to other electronic control circuits at the manufacturing process that control the execution of the manufacturing process) and used to adjust the settings of the process 350.

It will be appreciated that “settings” refers to operational parameters of machines used in the manufacturing processes such as the speed, temperature, force, or pressure utilized, created, and/or applied by these machines to the parts. In other words, the manufacturing processes 350 includes actual physical industrial machines and the electronic hardware/software used to operate these machines.

It will be appreciated by those skilled in the art that modifications to the foregoing embodiments may be made in various aspects. Other variations clearly would also work, and are within the scope and spirit of the invention. It is deemed that the spirit and scope of the invention encompasses such modifications and alterations to the embodiments herein as would be apparent to one of ordinary skill in the art and familiar with the teachings of the present application.

What is claimed is:

1. A method of fine-tuning manufacturing processes for components produced on a single manufacturing platform, the method comprising:
creating an electronic master work order, the work order including information concerning each of a batch of parts or components that have been constructed together on a single manufacturing platform, each of the parts or components being programmatically associated with the single electronic master work order;
tracking the individual parts or components as the individual parts or components move through or between a plurally of manufacturing processes or steps after the individual parts or components are separated from the single manufacturing platform;
wherein the information in the work order is utilized to dynamically make real-time adjustments to any of the plurality of manufacturing processes or steps as the individual parts or components move through or between the plurally of manufacturing processes or steps.

2. The method of claim 1, wherein the single manufacturing platform comprises a flat platter.

3. The method of claim 1, wherein the electronic master work order includes one or more of a part number of a part to be created, a part type, results of a destructive test, an identity of personnel that performed the test, and properties or attributes that were tested.

4. The method of claim 1, wherein each of the plurality of parts or components is automatically tracked, or wherein each of the individual parts or components is manually tracked.

5. The method of claim 1, wherein the electronic master work order includes testing information.

6. The method of claim 5, wherein the testing information comprises information associated with a destructive test.

7. The method of claim 6, wherein the destructive test involves an application of excess temperature, pressure, force, or motion.

8. The method of claim 1, wherein the adjustments are made by a technician, or the adjustments are accomplished automatically.

9. A system that is configured to fine-tune manufacturing processes for components produced on a single manufacturing platform, the system comprising:
a data storage device;
a user interface;
a control circuit that is coupled to the data store device and the user interface, the control circuit being configured to create an electronic master work order, the work order including information concerning each of a batch of parts or components that have been constructed together on a single manufacturing platform, each of the parts or components being programmatically associated with the single electronic master work order, the control circuit configured to store the electronic master work order in the data storage device;
wherein the individual parts or components are tracked as the individual parts or components move through or between a plurally of manufacturing processes or steps after the individual parts or components are separated from the single manufacturing platform;
wherein the information in the work order is utilized to dynamically make real-time adjustments to any of the plurality of manufacturing processes or steps as the individual parts or components move through or between the plurally of manufacturing processes or steps.

10. The system of claim 9, wherein the single manufacturing platform comprises a flat platter.

11. The system of claim 9, wherein the electronic master work order includes one or more of a part number of a part to be created, a part type, results of a destructive test, an identity of personnel that performed the test, and properties or attributes that were tested.

12. The system of claim 9, wherein each of the plurality of parts or components is automatically tracked by the control circuit according to sensed inputs, or wherein each of the individual parts or components is manually tracked by a human technician.

13. The system of claim 9, wherein the electronic master work order includes testing information.

14. The system of claim 13, wherein the testing information comprises information associated with a destructive test.

15. The system of claim 14, wherein the destructive test involves an application of excess temperature, pressure, force, or motion.

16. The system of claim 9, wherein the adjustments are made by a technician, or the adjustments are accomplished automatically by the control circuit.
